(19) United States
(12) Patent Application Publication
(10) Pub. No.: US 2015/0034214 A1
(43) Pub. Date: Feb. 5, 2015

(54) APPARATUS, SYSTEM, AND METHOD FOR REINFORCING A BEND IN METALLIC MATERIAL

(71) Applicant: Cummins IP, Inc., Columbus, IN (US)

(72) Inventors: Sanjay N. Thakur, Greenwood, IN (US); Yong-Ching Chen, Columbus, IN (US)

(73) Assignee: Cummins IP, Inc., Columbus, IN (US)

(21) Appl. No.: 13/957,855

(22) Filed: Aug. 2, 2013

(51) Int. Cl. B23K 20/12; C22F 1/04; C22F 1/00; C21D 1/34; C21D 1/667

(52) U.S. Cl. CPC B23K 20/1215; C21D 1/34; C21D 1/667; C22F 1/002; C22F 1/04; B23K 20/129; C21D 2221/00
USPC 148/512; 266/124; 228/2.1

(57) ABSTRACT

Described herein is an apparatus for reinforcing a metallic material includes a rotatable tool that is insertable into the metallic material. The rotatable tool is configured to plastically deform the metallic material. The apparatus also includes a coolant delivery mechanism that is coupled to the rotatable tool. The coolant delivery mechanism is configured to deliver a coolant to the metallic material.

### FIELD

This disclosure relates to the manufacture of metallic components with bends, and more particularly to reinforcing the bends of metallic components for extended use.

### BACKGROUND

Modern internal combustion engines are controlled by an engine control module (ECM). Generally, the ECM includes various electronic components that control the operation of the internal combustion engine, as well various sub-systems operatively coupled to the internal combustion engine. In automotive applications, the ECM is housed on a vehicle along with the internal combustion engine. Due to the potentially corrosive environment in which the ECM and internal combustion engine operate, conventional ECMs include a protective housing in which the electronic components are housed. Typically, the protective housing is made from a metal, such as aluminum, that is formed by bending a metallic sheet into a desired enclosed shape defining the interior of the ECM. Further, seams of the protective housing are sealed such that the interior of the ECM is sealed off from potentially harmful contaminants. Generally, the protective housing of an ECM is configured to remain permanently closed during its life cycle.

However, for various reasons, such as refurbishment or repair of the electronic components, the protective housing of an existing ECM is forcibly opened to expose the interior of the housing. Conventionally, an existing protective housing is opened by bending the metallic sheet along edges or corners of the housing in a direction opposite that used to bend the housing into its enclosed shape. When refurbishment operations on the interior of the housing are complete, the housing is again bent along the edges or corners into the original enclosed shape. Such reverse bending and re-bending of the housing tends to weaken the material along the bent edges or corners due to the formation of cracks. In some cases, the cracking is severe enough that housing can be completely severed along the bent edges or corners. Generally, after the original manufacture of an ECM, a conventional protective housing can be opened and closed no more than two times before the integrity of the housing fails, which severely limits the useful life of the ECM.

### SUMMARY

The subject matter of the present application has been developed in response to the present state of the art, and in particular, in response to the problems and needs associated with the refurbishment or repair of ECMs for internal combustion engines. Accordingly, the subject matter of the present application has been developed to provide an apparatus, system, and method for reinforcing the housing of an ECM to extend the useful life of the ECM, which overcomes at least some of the above-discussed shortcomings of prior art.

According to one embodiment, an apparatus for reinforcing a metallic material includes a rotatable tool that is insertable into the metallic material. The rotatable tool is configured to plastically deform the metallic material. The apparatus also includes a coolant delivery mechanism that is coupled to the rotatable tool. The coolant delivery mechanism is configured to deliver a coolant to the metallic material. The metallic material can include a bend, and wherein the rotatable tool can be insertable into the bend and configured to plastically deform the bend.

In some implementations of the apparatus, the coolant delivery mechanism delivers coolant to the metallic material before the rotatable tool plastically deforms the metallic material. The rotatable tool plastically deforms the metallic material to create a plastically deformed zone in the metallic material. The coolant delivery mechanism can deliver coolant to the plastically deformed zone or to the material before it's plastically deformed. The coolant delivery mechanism can deliver coolant to a heat affected zone adjacent the plastically deformed zone. The coolant delivery mechanism can deliver coolant to the rotatable tool.

According to certain implementations of the apparatus, the coolant is a fluid, and the coolant delivery mechanism can be configured to spray the fluid onto the metallic material. The fluid may include at least one of liquid nitrogen and compressed air.

In certain implementations of the apparatus, the metallic material includes a first surface and an opposing second surface. The rotatable tool penetrates the first surface and does not penetrating the second surface. The apparatus can additionally include a metallic strip positioned along the second surface. The metallic strip positioned along the second surface can be made from a metal that is different than the metallic material. The apparatus might further include a metallic strip positioned along the first surface, where the rotatable tool penetrates the metallic strip. The metallic strip positioned along the first surface can be made from a metal that is the same as the metallic material.

According to some implementations of the apparatus, the coolant delivery mechanism includes a hollow ring that encircles the rotatable tool. The hollow ring includes a plurality of apertures through which the coolant is delivered. The plurality of apertures may include at least one first aperture oriented to direct coolant onto the metallic material before the rotatable tool plastically deforms the metallic material and at least one second aperture oriented to direct coolant onto the metallic material after the rotatable tool plastically deforms the metallic material. The plurality of apertures may include at least one third aperture oriented to direct coolant onto the metallic material at a location adjacent a plastically deformed portion of the metallic material created by the rotatable tool. Further, the plurality of apertures can include at least one fourth aperture oriented to direct coolant onto the rotatable tool. In certain implementations, the coolant delivery mechanism includes a plurality of nozzles each coupled to the hollow ring in alignment with a respective one of the plurality of apertures.

In yet another embodiment, a method for reinforcing a metallic material includes friction stir processing the metallic material along a targeted area in a first direction using a tool. The method also includes applying a coolant onto the targeted area upstream of the tool as the tool moves along the targeted area in the first direction. Further, the method includes applying a coolant onto the targeted area downstream of the tool as the tool moves along the targeted area in the first direction.

In some implementations, the method also include applying a coolant onto the metallic material adjacent the targeted area as the tool moves along the targeted area in the first direction, and applying a coolant onto the tool as the tool moves along the targeted area in the first direction.

According to another embodiment, a system for reinforcing an engine control module (ECM) for an internal combustion engine along a bend formed in the ECM includes a friction stir processing tool. The friction stir processing tool includes a rotatable pin that is insertable into the bend formed in the ECM. The rotatable pin is movable along the bend in a first direction. Additionally, the rotatable pin is configured to plastically deform the bend. The system also includes a hollow annular ring that is fixedly positioned about the friction stir processing tool. The hollow annular ring includes at least one first aperture oriented to direct coolant onto the bend before the rotatable pin plastically deforms the bend. Also, the hollow annular ring includes at least one second aperture oriented to direct coolant onto the bend after the rotatable pin plastically deforms the bend. Further, the hollow annular ring includes at least one third aperture oriented to direct coolant onto the ECM at a location adjacent the bend. Additionally, the hollow annular ring includes at least one fourth aperture oriented to direct coolant onto the friction stir processing tool. The system also includes a coolant supply line in coolant providing communication with the hollow annular ring.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 is a perspective view of an engine control module in a closed configuration according to one embodiment;

FIG. 2 is a perspective view of the engine control module of FIG. 1, but in an open configuration according to one embodiment;

FIG. 3 is a perspective view of an engine control module in an open configuration and a friction stir processing tool that is reinforcing a bend of the module according to one embodiment;

FIG. 4 is a perspective view of an engine control module and a friction stir processing tool, as well as a first metal strip on the back side of the bend and a second metal strip on a front side of the bend, according to one embodiment;

FIG. 5 is a partial cross-sectional front view of a coolant delivery mechanism coupled to a friction stir processing tool according to one embodiment;

FIG. 6 is a partial cross-sectional end view of the coolant delivery mechanism coupled to the friction stir processing tool of FIG. 5;

FIG. 7 is a perspective view of a coolant delivery mechanism according to one embodiment;

FIG. 8 is a cross-sectional side view of the coolant delivery mechanism of FIG. 7;

FIG. 9 is a partial cross-sectional front view of a coolant delivery mechanism coupled to a friction stir processing tool according to another embodiment; and

FIG. 10 is a schematic flow diagram of a method for reinforcing a metallic material according to one embodiment.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

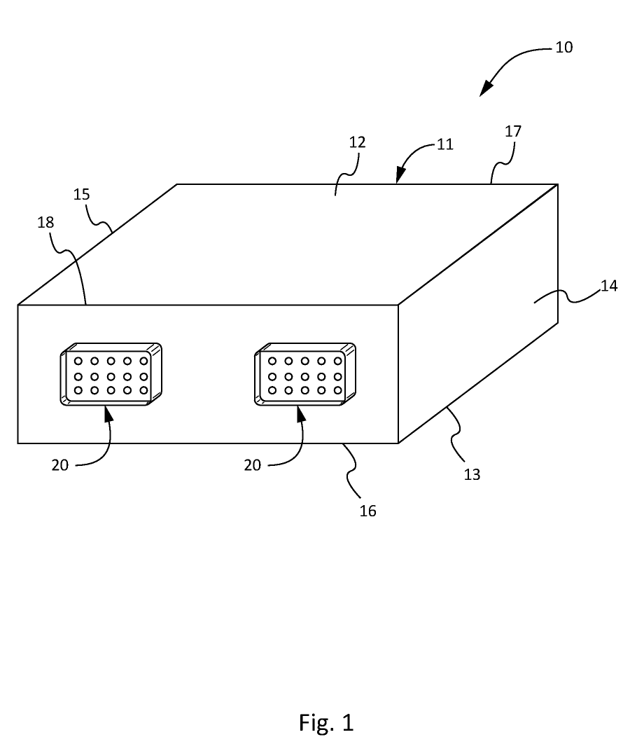

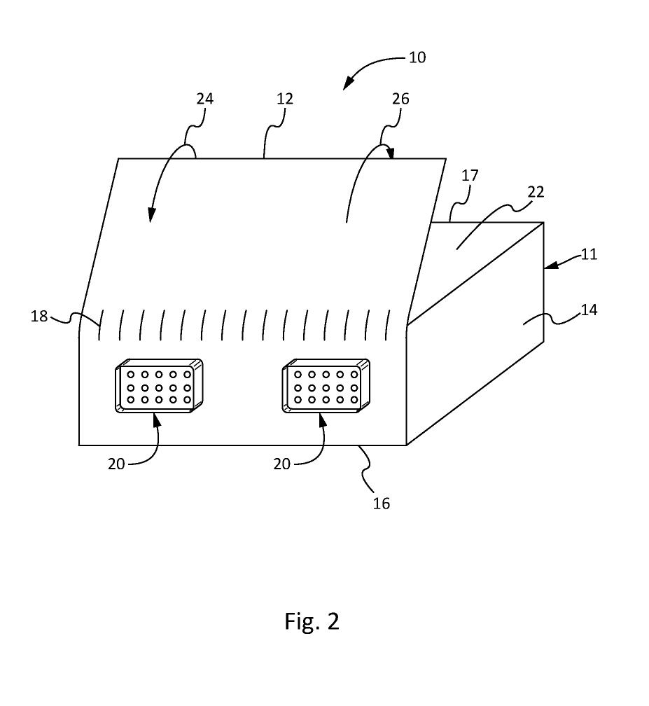

Referring to FIG. 1, an engine control module (ECM) 10 includes a housing 11 that contains electronic components for controlling operation of an internal combustion engine (not shown). As mentioned above, the ECM 10 can be located on a vehicle along with the internal combustion engine. The housing 11 is configured to seal off the electronic components from the potential harmful and corrosive contaminants, such as moisture and debris, found in the operating environment of the vehicle. In certain embodiments, the housing 11 is made from a sheet of material, such as aluminum, steel, iron, and magnesium, that is formed (e.g., bent, cast, molded) into a desired shape with an enclosed interior 22 (see, e.g., FIG. 2). In some implementations, the housing 11 has a plurality of sides defined between a plurality of bends or edges. For example, in the illustrated embodiment of FIG. 1, the housing 11 has a generally rectangular box-shape shape with a top panel 12, bottom panel 13, end panels 14, 15, and side panels 16, 17. In some embodiments, one or more of the panels of the housing includes one or more electronic interfaces 20 formed in the panels. The electronic interfaces 20 facilitate electronic communication with the electronic components contained within the housing.

The housing 11 also includes one or more bends 18 that define the panels. For example, the housing 11 includes a bend 18 that separates the top panel 12 from the side panel 16, as well as couples the top and side panels together. The top panel 12 is coupled to the end panels 14, 15 and the side panel 17 along separate edges of the panel, which can be coupled together using any of various coupling techniques, such as bonding, welding, and fastening. The seams along the separate edges of the panels can be sealed using any of various sealing techniques.

During formation of the housing 11, the top panel 12 can be bent along the bend 18 and moved in a closing direction into a sealing position relative to the top edges of the end panels 14, 15 and side panel 17 as shown by directional arrow 26 in FIG. 2. With the top panel 12 in the sealing position, the seams along the edges can be sealed. Bending of the top panel 12 along the bend 18 tends to diminish the strength of the material along the bend by disrupting the microstructure of the material and creating micro-cracks and macro-cracks.

As mentioned above, after forming and sealing the housing 11, in some instances, it may be desirable to physically access the interior 22 of the housing to refurbish or repair the components within the housing 11. Physical access to the interior 22 of the housing 11 is gained by breaking the seal along the seams between the top panel 12, end panels 14, 15, and side panel 17, and bending the top panel along the bend 18 in an opening direction away from the end panels and side panel as shown by direction arrow 24 in FIG. 2. As with bending of the top panel 12 along the bend 18 in the closing direction 26, bending the top panel 12 along the bend 18 in the opening direction 24 tends to further diminish the strength of the material along the bend by enlarging existing cracks and creating new cracks. After the top panel 12 has been opened, and refurbishment or repair of the electronic components within the housing 11 is completed, the top panel 12 is once again bent along the bend 18 in the closing direction 26 into the sealing position relative to the top edges of the end panels 14, 15 and side panel 17. Then, the seams along the edges are resealed and the refurbished housing 11 is put back into operation. Bending the top panel 12 back into the sealing position after an initial refurbishment of the ECM 10 further diminishes the strength of the material along the bend.

After an initial refurbishment of the ECM 10, in yet some instances, it may be desirable to conduct one or more additional refurbishments of the ECM. Such additional refurbishments are performed in the same manner as the initial refurbishment by opening the top panel 12, refurbishing the electrical components within the housing 11, and closing the top panel. Each time the top panel 12 is opened and closed during an additional refurbishment, the strength of the housing 11 along the bend 18 diminishes. Ultimately, after a certain number of opening and closing operations, the strength of the material along the bend 18 is sufficiently diminished or the bend completely fails (e.g., the top panel 12 physically separates from the side panel 16 along the bend 18) such that the housing is rendered inoperable for its intended purpose. Due to the expense associated with ECMs and the associated housings, it is desirable to extend the life of the ECMs by increasing the number of times a single ECM can be refurbished.

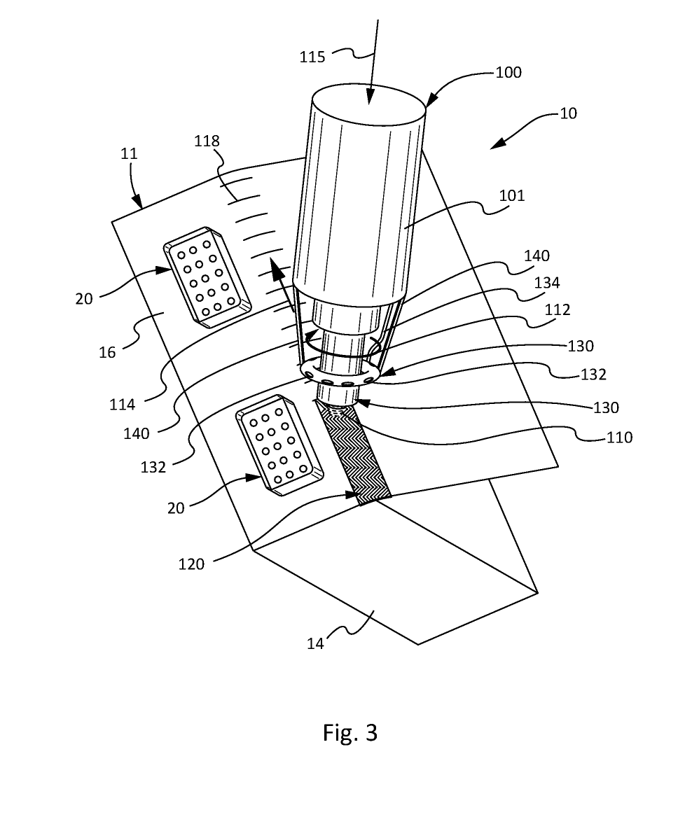

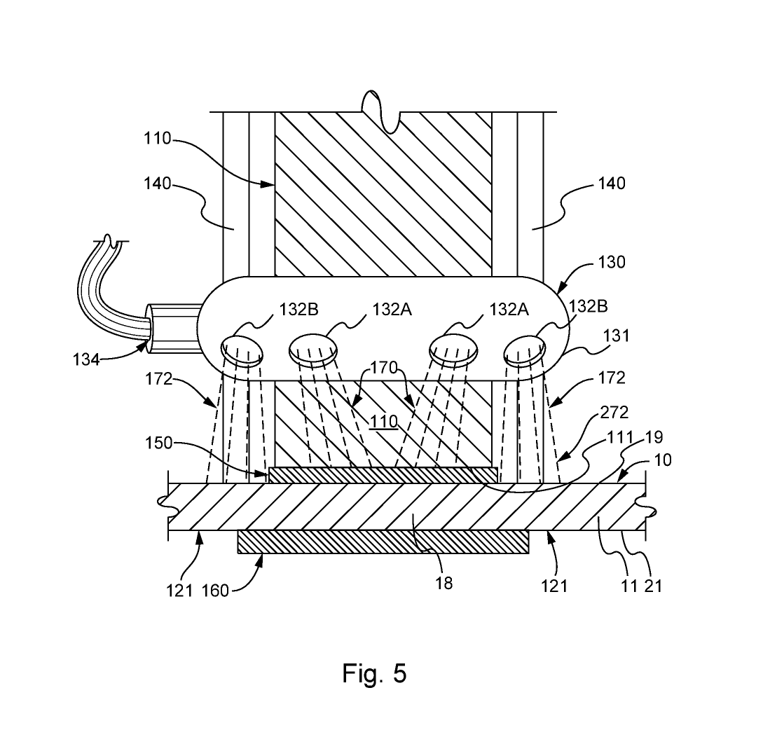

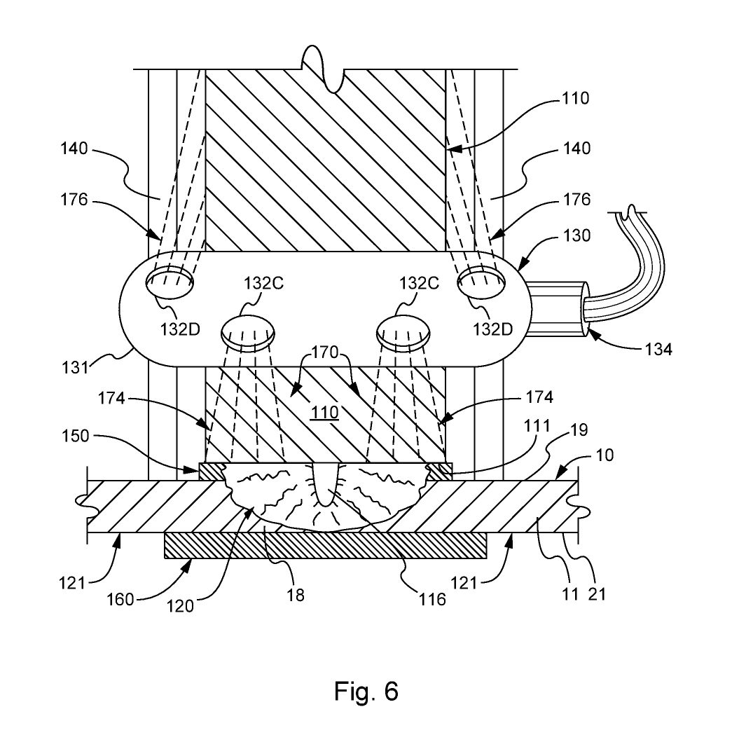

Referring to FIG. 3, a plastic deformation tool 100 and coolant delivery mechanism 130 coupled to the plastic deformation tool is shown that improves the strength of the bend 18 in the housing 11 and facilitates an increase in the number of times the ECM 10 can be refurbished. In some embodiments, the plastic deformation tool 100 is a friction stir processing tool to friction stir the material of the bend 18. The plastic deformation tool 100 includes a rotatable portion 110 that rotates in a direction as indicated by directional arrow 112 relative to the material to be processed. Because the tool 100 includes a rotatable portion, the tool can be defined as a rotatable tool. The rotatable portion 110 can be substantially cylindrically shaped with a substantially flat distal end 111 (see, e.g., FIG. 5). Extending from the flat distal end 111 is a pin or probe 116 (see, e.g., FIG. 6). The pin 116 includes a profile conducive to stirring the material of the bend 18. In some implementations, the pin 116 includes blades or threads that facilitate stifling of the material.

The friction stir processing operation facilitated by the plastic deformation tool 100 includes applying a downwardly directed force to the tool as indicated by arrow 115. The downwardly directed force 115 causes the pin 116 to penetrating the material of the bend 18, and causes the flat distal end 111 of the rotatable portion 110 to maintain contact with and apply pressure against an outer surface 19 of the bend. The contact between the rotatable portion 110 and the outer surface 19 of the bend 18 generates frictional heat as the rotatable portion rotates and the profile of the pin 116 stirs or mixes the heated material to create a plastic deformation zone 120 as the pin rotates (see, e.g., FIG. 5). While maintaining contact with the outer surface 19, keeping the pin 116 embedded in the material, and rotating the rotatable portion 110 and pin, the tool 100 is move translationally along the bend 18 in the direction indicated by directional arrow 114. In this manner, the tool 100 creates an elongate plastic deformation zone 120 along the length of the bend 18. The mixed material in the plastic deformation zone 120 has a more refined microstructure with more homogeneous grain structure than the original, non-mixed material. The refined microstructure improves the strength of the material along the bend 18.

Because the strength of the material of the bend 18 is increased, the material forming the bend is less susceptible to cracking. Accordingly, the plastic deformation tool 100 can be used to not only strengthen the bend 18, but to resist cracking as well. For this purpose, the housing 11 of the ECM 10 can be friction stir processed as described above during its original manufacture, as opposed to after initial production or during a refurbishing event.

Further, the mixing of the material along the bend 18 repairs cracks formed in the bend. Accordingly, the housing 11 of the ECM 10 can be friction stir processed as described above after its original manufacture during a refurbishing event. In some implementations, a single housing 11 can be friction stir processed multiple times during multiple refurbishing events.

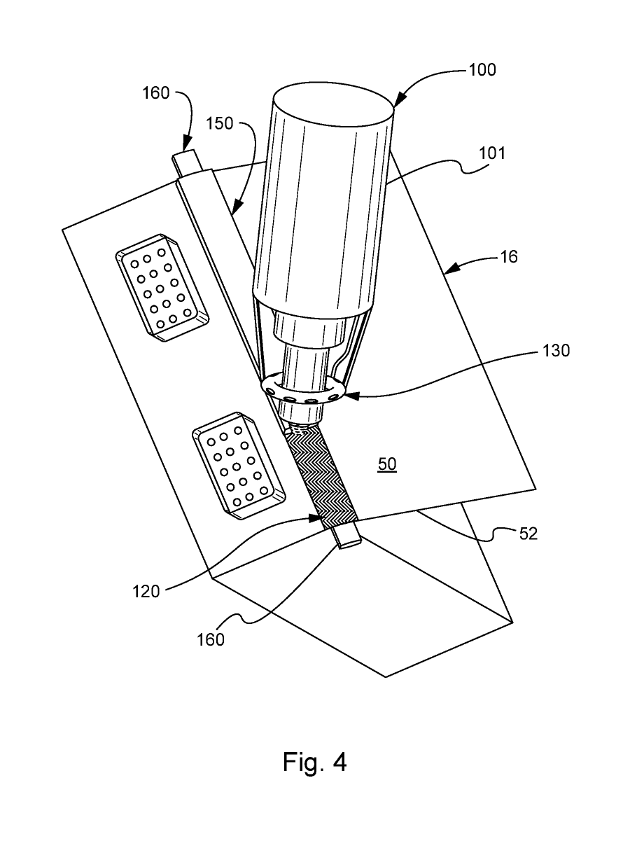

Referring to FIGS. 4 and 5, in some implementations, a first strip 160 made from a metallic material can be placed against an inner surface 21 of the bend 18 during the friction stir processing operation of the tool 100. The first strip 160 can be made from a metallic material that is different from the metallic material of the housing 11. In some implementations, the first strip 160 is made from a material that is harder than the material of the housing 11. For example, in one implementation, the first strip 160 is made from steel or similar material and the housing 11 is made from aluminum or similar material. The first strip 160 is configured to act as a stop to prevent the pin 116 from penetrating completely through the bend 18 of the housing 11. Additionally, the first strip 160 may be made from a material with a high thermal conductivity such that the first strip acts as a heat sink to transfer heat away from the housing 11 during the friction stir processing operation by the plastic deformation tool 100. After the friction stir processing operation on the housing 11, the first strip 160 can be removed from the inner surface 21 of the bend.

In yet some implementations, a second strip 150 made from a metallic material can be placed against the outer surface 19 of the bend 18 during the friction stir processing operation of the tool 100. The second strip 150 can be made from a metallic material that is the same as the metallic material of the housing 11. For example, in one implementation, the second strip 150 and the housing 11 are made from aluminum. As shown in FIG. 5, during the friction stir process operation, the second strip 150 is positioned between the outer surface 19 of the bend of the housing and the distal end 111 of the rotatable portion 110 of the tool 100. The distal end 111 of the rotatable portion 110 abuts the second strip 150 and the pin 116 penetrates the second strip 150 and the material of the bend 18. Further, the pin 116 stirs or mixes the second strip 150 along with the material of the bend 18 such that the material of the second strip is effectively added to the plastic deformation zone 120.

The friction stir processing operation performed by the plastic deformation tool 100 to reinforce the bend or wall of a metallic structure generates heat. The heat generation is most intense within the plastic deformation zone 120. However, significant amounts of heat is generated in or transferred to a heat affected zone 121 immediately surrounding the plastic deformation zone 120. For applications where the metallic structure is an ECM, such as ECM 10, the heat from the plastic deformation zone 120 and heat affected zone 121 can affect the electronic components within the housing of the ECM. In other words, heat from the plastic deformation zone 120 and heat affected zone 121 can be transferred to the electronic components of the ECM, which heat can damage or negatively affect the performance of the electronic components.

To reduce or dissipate the heat generated by the friction stir processing operation, the plastic deformation tool 100 includes a coolant delivery mechanism 130. The coolant delivery mechanism 130 is fixedly coupled to a non-rotatable portion 101 of the tool 100. The non-rotatable portion 101 of the tool 100 is stationary relative to the rotatable portion 110. Accordingly, as the rotatable portion 110 rotates, the non-rotatable portion 101 and the coolant delivery mechanism 130 remains stationary relative to the rotatable portion. Generally, as shown in FIG. 3, the coolant delivery mechanism 130 includes a hollow annular ring 131 fixedly coupled to the non-rotatable portion 101 of the tool 100 by one or more coupling elements 140. The hollow annular ring 131 delivers a coolant onto the material being processed by the rotatable portion 110 of the tool 100 and/or the rotatable portion of the tool itself.

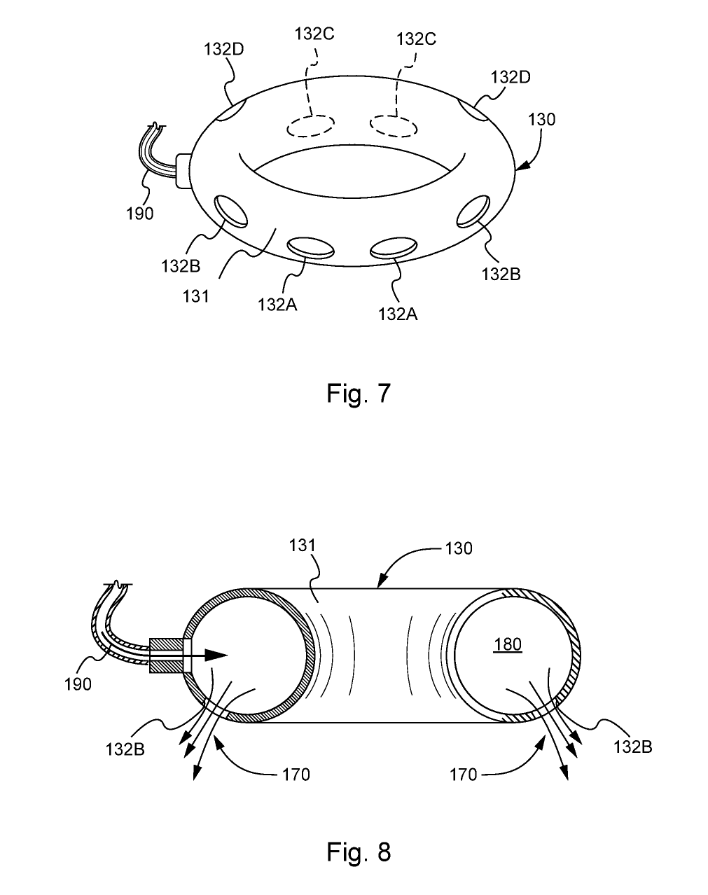

As shown in FIG. 3, in some embodiments, the hollow annular ring 131 is configured to fit about (e.g., encircle) the rotatable portion 110 of the tool 100. Accordingly, the ring 131 defines an inner aperture 133 sized to receive the rotatable portion 110 (see, e.g., FIG. 7). When the ring 131 is fixedly secured to the non- rotatable portion 101 by the coupling elements 140, the rotatable portion 110 extends through the inner aperture 133 such that the ring 131 encircles the rotatable portion at a desired location away from the material being processed. The size of the inner aperture 133 is large enough to allow the rotatable portion 110 to rotate within the inner aperture without interference with the ring. The coupling elements 140 can be any of various coupling elements configured to securely retain the ring 131 in the desired location about the rotatable portion 110. In one implementation, the coupling elements 140 are elongate stand-off rods or brackets each coupled at one end to the non-rotatable portion 101 of the tool and at an opposing end to the ring 131.

Referring to FIGS. 7 and 8, the hollow annular ring 131 defines an interior cavity 180 through which a coolant is flowable. The ring 131 also includes a plurality of apertures 132A-132D strategically sized and positioned about the ring. Each aperture extends through a wall of the ring 131 such that fluid within the interior cavity 180 is flowable out of the ring through the apertures 132A-132D. The coolant delivery mechanism 130 further includes a fluid supply line 190 (e.g., tube, hose, etc.) in fluid supplying communication with the interior cavity 180 of the ring 131. The fluid supply line 190 may receive fluid from a fluid source (not shown), such as a pressurized container housing the fluid. In some implementations, the fluid supply line 190 supplies a pressurized fluid into the interior cavity 180 of the ring 131. The pressurization of the fluid acts to force the fluid into the interior cavity 180 and out through the apertures 132A-132D in respective localized and defined fluid streams. The size and position of the apertures 132A-132D defines the shape, velocity, and direction of the fluid streams being expelled from the respective apertures. Generally, the smaller the size of the aperture, the higher the velocity of the stream and the narrower the stream.

The fluid can be any of various fluid coolants. In one embodiment, the fluid coolant is a combination of liquid nitrogen and compressed air. In some implementations, the fluid coolant is exclusively liquid nitrogen or exclusively compressed air. In yet some implementations, the fluid coolant can be other fluids, such as gases (e.g., nitrogen, air, hydrogen, inert gases, and the like) and liquids (e.g., water, glycol, cutting fluid, oils, freons, refrigerants, and the like).

According to some embodiments, the ring 131 includes respective pairs of upstream apertures 132A, lateral apertures 132B, downstream apertures 132C, and tool apertures 132D. The upstream apertures 132A are positioned spaced apart from each other on a leading portion of the ring 131. Further, the upstream apertures 132A are positioned on a lower surface of the ring 131 such that the upstream apertures face downwardly toward the outer surface 19 of the housing 11 upstream of the tool 100. The lateral apertures 132B are positioned on respective side portions of the ring 131, and on the lower surface of the ring, such that the lateral apertures face downwardly toward the outer surface 19 of the housing 11 laterally adjacent the tool. The downstream apertures 132C are positioned spaced apart from each other on a trailing portion of the ring 131. Further, the downstream apertures 132C are positioned on a lower surface of the ring 131 such that the downstream apertures face downwardly toward the outer surface 19 of the housing 11 downstream of the tool 100. The tool apertures 132D are positioned on respective side portions of the ring 131, and on the upper-side surface of the ring, such that the tool apertures face upwardly at an angle toward the rotatable portion 110 of the tool 100. In certain implementations, the tool apertures 132D can be positioned on the side surface or lower-side surface of the ring such that the tool apertures faced sideways or downwardly at an angle toward the rotatable portion 110 of the tool 100, respectively.

Referring to FIG. 5, which provides a downstream perspective, as the plastic deformation tool 100 moves along the bend 18 in the direction 114, coolant fluid in the ring 131 is expelled from the upstream apertures 132A as fluid streams 170. Due to the position of the upstream apertures 132A on the ring 131, the fluid streams 170 are directed onto the material of the housing 11 forming the bend (and the second strip 150 if applicable) before the material (and second strip) is plastically deformed by the tool 100. In other words, the fluid streams 170 are sprayed onto the housing 11 upstream or in front of the tool 100 to cool the material of the bend 18 in preparation for plastic deformation by the tool. Such advanced cooling of the material reduces maximum heat generation during the friction stir processing operation by the tool, and helps improve the micro-hardness or microstructure of the plastically deformed material.

Referring again to FIG. 5, as the plastic deformation tool 100 moves along the bend 18 in the direction 114, coolant fluid in the ring 131 is expelled from the lateral apertures 132B as fluid streams 172. Due to the position of the lateral apertures 132B on the ring 131, the fluid streams 172 are directed onto the material of the housing 11 to the sides of the bend 18 before, during, and/or after the material of the bend is plastically deformed by the tool 100. In other words, the fluid streams 172 are sprayed onto the housing 11 to the sides of the bend 18 to cool the heat affected zone 121. Cooling of the heat affected zone 121 reduces the heat transfer to portions of the housing 11 adjacent the bend 18, including the electrical components housed by the housing.

Referring to FIG. 6, as the plastic deformation tool 100 moves along the bend 18 in the direction 114 to create the plastic deformation zone 120 along the length of the bend, coolant fluid in the ring 131 is expelled from the downstream apertures 132C as fluid streams 174. Due to the position of the downstream apertures 132B on the ring 131, the fluid streams 174 are directed onto the plastic deformation zone 120 that is newly formed in the material of the bend 18 by the tool 100. Accordingly, after the material of the bend 18 is plastically deformed by the tool 100, the coolant delivery mechanism 130 sprays coolant onto the plastically deformed material to cool the material. Such post cooling of the plastically deformed material dissipates heat generated during the friction stir processing operation and improves the micro-hardness or microstructure of the plastically deformed material.

Referring again to FIG. 6, as the plastic deformation tool 100 moves along the bend 18 in the direction 114 to create the plastic deformation zone 120 along the length of the bend, coolant fluid in the ring 131 is expelled from the tool apertures 132D as fluid streams 176. Due to the position of the tool apertures 132D on the ring 131, the fluid streams 176 are directed onto the rotatable portion 110 of the tool as it rotates. Accordingly, while the tool 100 is in operation, the coolant delivery mechanism 130 sprays coolant onto the tool to cool the tool. Such cooling of the tool 100 dissipates heat generated by the tool, which reduces the amount of heat transferred to the electronic components in the housing 11 during the friction stir processing operation.

Although in the illustrated embodiments of FIGS. 7 and 8, the composition of the coolant entering the ring 131 and exiting the ring through the apertures 132A-132D as fluid streams 170, 172, 174, 176 is the same. However, it is contemplated that the tool 100 can be configured such that the composition of the coolant (e.g., the ratio of liquid nitrogen to compressed air) exiting the respective apertures 132A-132D as fluid streams 170, 172, 174, 176 can be different. For example, each aperture 132A-132D or pair of apertures can be coupled to separate coolant supply lines each supplying the apertures with different compositions of coolant.

Additionally, although the ring 131 in the illustrated embodiments of FIGS. 5-8 includes two upstream apertures 132A, two lateral apertures 132B, two downstream apertures 132C, and two tool apertures 132D, in other embodiments, the ring may include fewer or more than two of each of the upstream, lateral, downstream, and tool apertures. For example, should more cooling or heat dissipation be desired after the plastic deformation zone 120 is formed, then the ring 131 may have more than two downstream apertures and less than two upstream apertures.

Further, although the hollow annular ring 131 in the illustrated embodiments of FIGS. 1-8 is configured to fit about the rotatable portion 110 of the tool 100, in other embodiments, the annular ring can be configured to fit about (e.g., encircle) or be coupled to the non-rotatable portion 101 of the tool in any of various manners as desired.

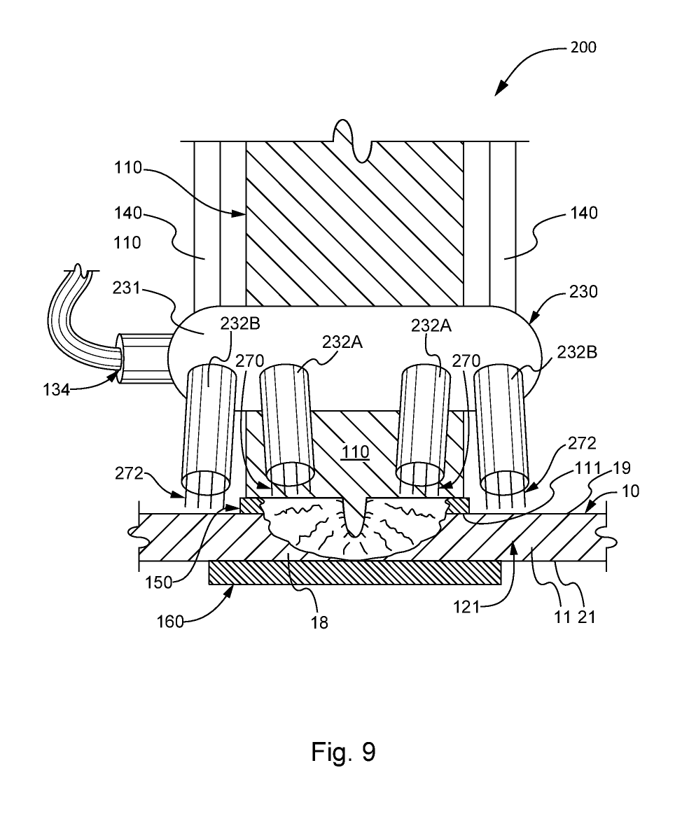

Referring to FIG. 9, in some embodiments, a tool 200 is shown that has features similar to the features of the tool 100, with like numbers referring to like features. Similar to the tool 100, the tool 200 includes a coolant delivery mechanism 230 with a hollow annular ring 231. Although not shown, the hollow annular ring 231 includes a plurality of apertures similar to the apertures of the ring 131. However, to improve the precision of the delivery of coolant to a localized desired location, the coolant delivery mechanism 230 includes a plurality of nozzles each coupled to the hollow ring in alignment with a respective one of the plurality of apertures. As shown, the coolant delivery mechanism 230 includes a pair of nozzles 232A fluidly coupled to a pair of upstream apertures formed in the ring 231. Additionally shown are a pair of nozzles 232B fluidly coupled to a pair of lateral apertures formed in the ring 231. Although not shown, the coolant delivery mechanism 230 can include downstream and tool apertures with corresponding nozzles fluidly coupled thereto.

Each of the nozzles includes a hollow tubular structure that defines an elongate fluid conduit through which coolant exiting a corresponding aperture of the ring 231 flows. In this manner, the nozzles act to guide coolant from the apertures to a desired location on the housing 11. For example, the nozzles 232A each deliver a stream 270 of coolant onto the housing 11 upstream or in front of the tool 100 to cool the material of the bend 18 in preparation for plastic deformation by the tool. Similarly, the nozzles 232B each deliver a stream 272 of coolant onto the housing 11 to the sides of the bend 18 to cool the heat affected zone 121. The elongate fluid conduit of the nozzles can have a constant cross-sectional area in some implementations. In yet some implementations, the cross-sectional area of the elongate fluid conduit of the nozzles change along a length of the nozzles. For example, the elongate fluid conduits can converge in a coolant flow direction to accelerate the coolant.

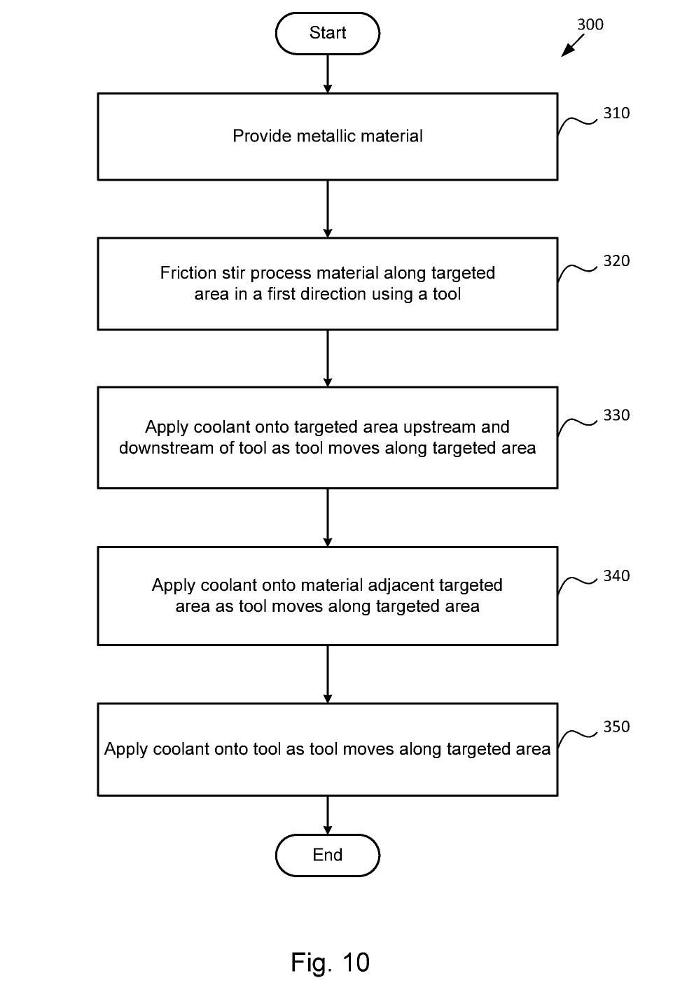

In some embodiments, the plastic deformation tools 100, 200 can be used in a method for reinforcing a metallic material. According to one embodiment show in FIG. 10, one method 300 for reinforcing a metallic material includes providing a metallic material at 310, which can be a housing of an ECM. The method 300 further includes friction stir processing the metallic material along a targeted area in a first direction using a tool at 320. The targeted area can be a bend of an ECM housing or other structure, and the tool can be a plastic deformation tool as described herein. The method 300 includes applying coolant onto the targeted area upstream and/or downstream of the tool as the tool moves along the targeted area at 330. Applying coolant onto the targeted area upstream cools the area before being plastically deformed by the friction stir process of step 320, and applying coolant onto the targeted area downstream cools the area after being plastically deformed by the friction stir process of step 320. The method 300 may also include applying coolant onto the material at a location adjacent the targeted area as the tool moves along the targeted area at 340. The location adjacent the targeted area may be a non-plastically deformed area, but may nevertheless be affected by the heat generated by the friction stir processing of the material at 320. The method 300 may additionally include applying coolant onto the tool as the tool friction stir process the material and moves along the targeted area at 350. The coolant can be applied to any portion of the tool, but in some implementations, it is applied to the rotating portion or portions of the tool.

Although in the illustrated embodiments, the bend that is processed by the plastic deformation tool 100 is between a top panel and side panel of a generally rectangular-shaped housing, in other embodiments any of various bends of an ECM housing having any of various shapes can be processed by the plastic deformation tool 100 in the manner described above. Additionally, it is recognized that the plastic deformation tool 100 can be used to reinforce a bend in a metallic structure other than the housing of an automotive ECM.

In the above description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

Any schematic flow chart diagrams included herein are generally set forth as logical flow chart diagrams. As such, the depicted order and labeled steps are indicative of one embodiment of the presented apparatus, system, or method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for reinforcing a metallic material, comprising:
a rotatable tool insertable into the metallic material, the rotatable tool configured to plastically deform the metallic material; and
a coolant delivery mechanism coupled to the rotatable tool, the coolant delivery mechanism being configured to deliver a coolant to the metallic material.

2. The apparatus of claim 1, wherein the coolant delivery mechanism delivers coolant to the metallic material before the rotatable tool plastically deforms the metallic material.

3. The apparatus of claim 2, wherein the rotatable tool plastically deforms the metallic material to create a plastically deformed zone in the metallic material, and wherein the coolant delivery mechanism delivers coolant to the plastically deformed zone.

4. The apparatus of claim 3, wherein the coolant delivery mechanism delivers coolant to a heat affected zone adjacent the plastically deformed zone.

5. The apparatus of claim 4, wherein the coolant delivery mechanism delivers coolant to the rotatable tool.

6. The apparatus of claim 1, wherein the coolant comprises a fluid, and wherein the coolant delivery mechanism is configured to spray the fluid onto the metallic material.

7. The apparatus of claim 6, wherein the fluid comprises at least one of liquid nitrogen and compressed air.

8. The apparatus of claim 1, wherein the metallic material comprises a first surface and an opposing second surface, the rotatable tool penetrating the first surface and not penetrating the second surface, the apparatus further comprising a metallic strip positioned along the second surface.

9. The apparatus of claim 8, wherein the metallic strip is made from a metal that is different than the metallic material.

10. The apparatus of claim 1, wherein the metallic material comprises a first surface and an opposing second surface, the rotatable tool penetrating the first surface and not penetrating the second surface, the apparatus further comprising a metallic strip positioned along the first surface, wherein the rotatable tool penetrates the metallic strip.

11. The apparatus of claim 10, wherein the metallic strip is made from a metal that is the same as the metallic material.

12. The apparatus of claim 1, wherein the metallic material comprises a bend, and wherein the rotatable tool is insertable into the bend and configured to plastically deform the bend.

13. The apparatus of claim 1, wherein the coolant delivery mechanism comprises a hollow ring encircling the rotatable tool, the hollow ring comprising a plurality of apertures through which the coolant is delivered.

14. The apparatus of claim 13, wherein the plurality of apertures comprises at least one first aperture oriented to direct coolant onto the metallic material before the rotatable tool plastically deforms the metallic material and at least one second aperture oriented to direct coolant onto the metallic material after the rotatable tool plastically deforms the metallic material.

15. The apparatus of claim 14, wherein the plurality of apertures comprises at least one third aperture oriented to direct coolant onto the metallic material at a location adjacent a plastically deformed portion of the metallic material created by the rotatable tool.

16. The apparatus of claim 15, wherein the plurality of apertures comprises at least one fourth aperture oriented to direct coolant onto the rotatable tool.

17. The apparatus of claim 13, wherein the coolant delivery mechanism comprises a plurality of nozzles each coupled to the hollow ring in alignment with a respective one of the plurality of apertures.

18. A method for reinforcing a metallic material, comprising:
friction stir processing the metallic material along a targeted area in a first direction using a tool;
applying a coolant onto the targeted area upstream of the tool as the tool moves along the targeted area in the first direction; and
applying a coolant onto the targeted area downstream of the tool as the tool moves along the targeted area in the first direction.

19. The method of claim 18, further comprising:
applying a coolant onto the metallic material adjacent the targeted area as the tool moves along the targeted area in the first direction; and
applying a coolant onto the tool as the tool moves along the targeted area in the first direction.

20. A system for reinforcing an engine control module (ECM) for an internal combustion engine along a bend formed in the ECM, comprising:
a friction stir processing tool comprising a rotatable pin that is insertable into the bend formed in the ECM and movable along the bend in a first direction, wherein the rotatable pin is configured to plastically deform the bend;
a hollow annular ring fixedly positioned about the friction stir processing tool, the hollow annular ring comprising at least one first aperture oriented to direct coolant onto the bend before the rotatable pin plastically deforms the bend, at least one second aperture oriented to direct coolant onto the bend after the rotatable pin plastically deforms the bend, at least one third aperture oriented to direct coolant onto the ECM at a location adjacent the bend, and at least one fourth aperture oriented to direct coolant onto the friction stir processing tool; and
a coolant supply line in coolant providing communication with the hollow annular ring.
